(19) United States
(12) Patent Application Publication
(10) Pub. No.: US 2024/0111062 A1
(43) Pub. Date: Apr. 4, 2024

(54) POLARIZATION FUSION ORIENTATION METHOD FOR OCCLUDED ENVIRONMENT

(71) Applicant: NORTH UNIVERSITY OF CHINA, Taiyuan (CN)

(72) Inventors: Chong SHEN, Taiyuan (CN); Huijun ZHAO, Taiyuan (CN); Jun LIU, Taiyuan (CN); Jun TANG, Taiyuan (CN); Huiliang CAO, Taiyuan (CN); Chenguang WANG, Taiyuan (CN)

(21) Appl. No.: 18/332,788

(22) Filed: Jun. 12, 2023

(30) Foreign Application Priority Data
Sep. 22, 2022 (CN) 202211169884.4

(51) Int. Cl. G01S 19/37; G01S 19/39

(52) U.S. Cl. CPC G01S 19/37; G01S 19/393

(57) ABSTRACT

Disclosed is a polarization fusion orientation method for an occluded environment, which comprises: acquiring a sky polarization image through a polarization camera first, then taking a heading angle output by an E-vector polarization orientation method as a state quantity, taking a heading angle output by a symmetry axis polarization orientation method as an observed quantity, realizing heading angle fusion through a multi-frequency variational Bayesian strong tracking cubature Kalman filter (MF-VBSTCKF), and respectively selecting different methods for a sampling position and a sampling interval period to update an optimal heading angle. The method solves the problem that high-precision and high-robustness heading angle measurement of polarized light cannot be realized in the occluded environment, can improve the precision and robustness of a polarized light orientation method in the occluded environment, and ensures high-frequency output of the heading angle at the same time.

### CROSS-REFERENCE TO RELATED APPLICATIONS

This application claims priority to Chinese Patent Application Ser. No. CN202211169884.4 filed on 22 Sep. 2022.

### TECHNICAL FIELD

The present invention relates to the technical field of polarized light orientation and information fusion, and particularly to a polarization fusion orientation method for an occluded environment.

### BACKGROUND

Navigation technology is an important technology for providing a continuous, safe and reliable service for a carrier, and an inertial navigation system (INS) and a global navigation satellite system (GNSS) are the most widely used navigation systems at present. However, in some cases, they may become unreliable. For example, navigation errors of the INS are accumulated with time, and signals of the GNSS are vulnerable to electromagnetic interference. With the in-depth study of an animal navigation mechanism, a polarization orientation technology has been applied to various unmanned platforms such as an unmanned vehicle and an unmanned aerial vehicle due to excellent performances such as long endurance, high precision and anti-electromagnetic interference.

Although remarkable progresses have been made in polarization orientation methods, such as an E-vector polarization orientation method with high orientation precision and real-time performance in sunny days and a symmetry axis polarization orientation method with strong anti-interference ability in an occluded environment, these methods still have some limitations. In particular, due to the lack of consideration of different shielding conditions such as clouds, trees and buildings, a polarization compass cannot exert the advantages of real-time performance and high precision in the occluded environment. Therefore, it is difficult to realize high precision and high real-time polarization orientation in the occluded environment.

### SUMMARY

Object of invention: in order to solve the problem in the prior art that it is difficult to realize high-precision and high-real-time heading angle measurement by a polarized light compass in an occluded environment, the present invention provides a polarization fusion orientation method for an occluded environment.

Technical solution: a polarization fusion orientation method for an occluded environment comprises the following steps of:
step 1: acquiring a sky polarization image through a polarization camera, and calculating a heading angle by an E-vector polarization orientation method and a symmetry axis polarization orientation method respectively according to the sky polarization image, wherein when the fitting symmetry axis polarization orientation method is used, a sampling frequency is relatively low as the image needs to be redrawn;
step 2: taking the heading angle output by the E vector polarization orientation method as a state quantity, taking the heading angle output by the fitting symmetry axis polarization orientation method as an observed quantity, and inputting the state quantity and the observed quantity into a multi-frequency variational Bayesian strong tracking cubature Kalman filter to perform heading angle fusion; and
step 3: making a high-frequency state quantity and a low-frequency observed quantity exist in a low-frequency observed quantity sampling position when an observation matrix is given, calculating a residual error and an estimation error by using the observation matrix, and then updating an optimal heading angle at the moment through the multi-frequency variational Bayesian strong tracking cubature Kalman filter; and
making the low-frequency observed quantity non-exist during a low-frequency observed quantity sampling interval period when a state transition matrix is given, updating the estimation error by using the state transition matrix, updating the residual error by using the estimation error updated, and updating the optimal heading angle by using the residual error updated.

Further, in the step 1, in the E vector polarization orientation method, polarization information of a zenith region is calculated first, a solar azimuth φ_{S} in a navigation coordinate system is acquired by consulting a solar ephemeris, and then the heading angle is acquired according to an E vector of incident light perpendicular to a plane composed of an observation direction and a solar vector in a Rayleigh scattering theory; and
in the fitting symmetry axis polarization orientation method, a polarization angle image is redrawn and a point with an AOP value close to 90° is selected to fit a solar meridian by calculating polarization information of all regions, an included angle αₛ between the solar meridian and a carrier axis in a camera coordinate system is determined finally, and the heading angle is calculated by φₛ, αₛ;
the heading angles of the two methods are respectively calculated according to ϕ, φₛ, αₛ:

φₑ=90°−ϕ+φ_{S} (6)

φ_{b}=αₛ−φ_{S} (7)
wherein, φₑ is the heading angle obtained by the E vector polarization orientation method, ϕ is the polarization angle, φₛ is the solar azimuth in the navigation coordinate system, and φ_{b} is the heading angle obtained by the fitting symmetry axis polarization orientation method.

Further, in the step 2, a specific method of the heading angle fusion comprises:
assuming that the high-frequency state quantity and the low-frequency observed quantity both exist, approximating a joint posterior distribution of the state quantity and an observation noise variance by a variational Bayesian method based on the multi-frequency variational Bayesian strong tracking cubature Kalman filter, wherein the joint posterior distribution is expressed as a product of a Gaussian distribution and an inverse gamma distribution:

p(xₖ,Rₖ|z_{1:k})≈N(xₖ|\hat{x}ₖ,Pₖ)IG(Rₖ|λₖ,μₖ) (8)
wherein, p(xₖ, Rₖ|z_{1:k}) is a joint posterior distribution at a k moment, Pₖ is a covariance of filtering estimation at the k moment, xₖ, zₖ respectively represent a state quantity and an observed quantity at the k moment, \hat{x}ₖ represents an estimated value of the state quantity at the k moment, λₖ, μₖ are parameters of the inverse gamma distribution, N(·) represents the Gaussian distribution, IG(·) represents the inverse gamma distribution, and the observation noise variance Rₖ is calculated by the following formula:

Rₖ=(λₖ−n−1)⁻¹μₖ (9)
wherein, n is a number of dimensions of the observed quantity, and λₖ and μₖ are updated by the following formulas:

$${λ}_{k} = 1 + {λ}_{k / k - 1} \qquad ( 10 )$$

$${μ}_{k} = {μ}_{k / k - 1} + \frac{1}{m} {\sum }_{j = 1}^{m} ( {z}_{k} - {z}_{k , j} ) {( {z}_{k} - {z}_{k , j} )}^{T} \qquad ( 11 )$$

wherein, λ_{k/k-1} and μ_{k/k-1} are parameters of an inverse gamma distribution from a k−1 moment to the k moment, m=2n is a number of cubature points, j=1, 2, . . . , m, and z_{k,j} is an observed quantity of a j^{th} cubature point; and
meanwhile, adjusting P_{k/k-1} in real time by introducing a fading factor τₖ based on the multi-frequency variational Bayesian strong tracking cubature Kalman filter,

$${P}_{k / k - 1} = \frac{{τ}_{k}}{m} {\sum }_{j = 1}^{m} [ {{x}_{k / k - 1 , j} ( {x}_{k / k - 1 , j} )}^{T} - {{\hat{x}}_{k / k - 1} ( {\hat{x}}_{k / k - 1} )}^{T} ] + {Q}_{k} \qquad ( 12 )$$

wherein, P_{k/k-1} represents a covariance of filtering estimation from the k−1 moment to the k moment, x_{k/k-1,j} represents a predicted value of a state quantity of the j^{th} cubature point from the k−1 moment to the k moment, \hat{x}_{k/k-1} represents a predicted value of a state quantity from the k−1 moment to the k moment, Qₖ is a state noise variance, and τₖ is expressed as:

$${τ}_{k} = \frac{tr ( {V}_{k} - {R}_{k} )}{t r ( \frac{1}{m} {\sum }_{j = 1}^{m} {{z}_{k / k - 1 , j} ( {z}_{k / k - 1 , j} )}^{T} - {{\hat{z}}_{k / k - 1} ( {\hat{z}}_{k / k - 1} )}^{T} )} \qquad ( 13 )$$

$${V}_{k} = \{ \begin{matrix}{γ}_{k} {γ}_{k}^{T} , k = 1 \\ \frac{ρ {V}_{k - 1} + {γ}_{k} {γ}_{k}^{T}}{1 + ρ} , k > 1\end{matrix} \qquad ( 14 )$$

wherein, tr(·) represents a trace of a matrix, Vₖ is a covariance matrix of the residual error, z_{k/k-1,j} represents a predicted value of the observed quantity of the j^{th} cubature point from the k−1 moment to the k moment, \hat{z}_{k/k-1} represents a predicted value of the observed quantity from the k−1 moment to the k moment, ρ is a forgetting factor, and has a value of ρ=0.95, and γₖ is the residual error, and is expressed as:

γₖ=zₖ−Hₖ\hat{x}_{k/k-1} (15)
wherein, Hₖ represents the observation matrix.

Further, in the step 3, the high-frequency state quantity and the low-frequency observed quantity both exist in the low-frequency observed quantity sampling position, and calculation formulas of the residual error, the estimation error and the optimal heading angle are as follows:

γₖ=zₖ−Hₖ\hat{x}_{k/k-1} (15)

βₖ=xₖ−\hat{x}ₖ=((Hₖ^{T}−Hₖ)⁻¹Hₖ^{T}−Kₖ)γₖ (16)

\hat{x}ₖ=\hat{x}_{k/k-1}+Kₖ(zₖ−\hat{z}_{k/k-1}) (17)
wherein, γₖ, βₖ are respectively a residual error and an estimation error at the k moment, xₖ, zₖ respectively represent a state quantity and an observed quantity at the k moment, \hat{x}ₖ represents an estimated value of the state quantity at the k moment, \hat{x}_{k/k-1} represents a predicted value of a state quantity from the k−1 moment to the k moment, Hₖ represents the observation matrix, Kₖ is a Kalman filtering gain, and \hat{z}_{k/k-1} represents a predicted value of an observed quantity from the k−1 moment to the k moment.

Further, in the step 3, the low-frequency observed quantity does not exist during the low-frequency observed quantity sampling interval period, and calculation formulas of the estimation error, the residual error and the optimal heading angle are as follows:

βₖ₊₁≈Fₖβₖ (21)

γₖ₊₁≈HₖFₖ·βₖ (22)

\hat{x}ₖ₊₁=\hat{x}_{k+1/k}+∈ₖ₊₁γₖ₊₁ (23)
wherein, βₖ₊₁, γₖ₊₁ respectively represent an estimation error and a residual error at the k+1 moment, Fₖ is the state transition matrix of the system, \hat{x}ₖ₊₁ represents an estimated value of a state quantity at the k+1 moment, \hat{x}_{k+1/k} represents a predicted value of a state quantity from the k moment to the k+1 moment, and ∈ₖ₊₁=diag([∈_{1,k}, ∈_{2,k}, . . . ∈_{n,k+1}]) is an adjusting factor.

Beneficial effects: compared with the prior art, the present invention provides the polarization fusion orientation method for the occluded environment, which integrates the E vector polarization orientation method and the fitting symmetry axis polarization orientation method, and simultaneously solves the problems of poor precision of the E vector polarization orientation method and poor real-time performance of the fitting symmetry axis polarization orientation method in the occluded environment, so that the polarized light compass can also realize high-precision and high-real-time orientation in the occluded environment, and the robustness of the polarized light compass is improved;
the fading factor is introduced to adjust an output of a gain matrix, so that a system state is tracked quickly. Meanwhile, taking the system state and the observation noise variance as variables to be estimated, the posterior distribution of the observation noise is obtained by iterative approximation of variational Bayesian learning before each recursive state estimation, thus improving the estimation precision of the heading angle; and
the multi-frequency data fusion algorithm based on residual error compensation is introduced to solve the problem of data fusion caused by different sampling frequencies, and high-frequency data is subjected to time updating and residual error compensation in a low-frequency data sampling interval position, thus realize seamless fusion and output of the heading angle.

### BRIEF DESCRIPTION OF THE DRAWINGS

FIG. 1 is a flow chart of a polarization fusion orientation method for an occluded environment;

FIG. 2 is a schematic diagram of a multi-frequency variational Bayesian strong tracking cubature Kalman filter;

FIG. 3 is an error graph of a heading angle of the present invention in a static occluded environment; and

FIG. 4 is an error graph of a heading angle of the present invention in a dynamic occluded environment.

### DETAILED DESCRIPTION

The present invention is further explained and described hereinafter with reference to the drawings and specific embodiments.

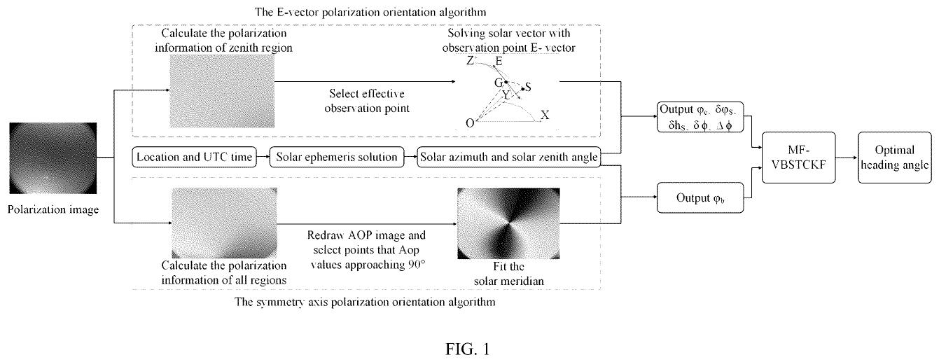

As shown in FIG. 1, a polarization fusion orientation method for an occluded environment comprises the following steps.

In step 1, a sky polarization image is acquired through a polarization camera, and a heading angle is calculated by an E-vector polarization orientation method and a symmetry axis polarization orientation method respectively according to the sky polarization image, wherein when the fitting symmetry axis polarization orientation method is used, a sampling frequency is relatively low as the image needs to be redrawn.

In the embodiment, in the E vector polarization orientation method, polarization information of a zenith region is calculated through the sky polarization image first, an effective observation point G is selected, and an observation direction in an incident light coordinate system i may be expressed as:

\vec{OᵢG}=[0 0 1]^{T} (1)
wherein, O represents a position of a polarization compass;
in the incident light coordinate system i, a direction of an E vector of incident light may be expressed by a polarization angle ϕ:

\vec{GE}=[cos Ø sin Ø0]^{T} (2)
a solar vector \vec{OS} in a navigation coordinate system may be expressed as:

\vec{OS}=[cos h_{S} cos φ_{S} cos h_{S} sin φ_{S} sin h_{S}]^{T} (3)
wherein, φₛ and hₛ are an azimuth and a high angle of the sun in the navigation coordinate system calculated through a solar ephemeris;
then according to a Rayleigh scattering model, the E vector of incident light is perpendicular to a plane composed of the observation direction and the solar vector, so that:

\vec{GE}=c[\vec{OᵢG}]ₓCₙⁱ\vec{OS} (4)
wherein, c is a constant capable of making the moduli on two sides equal, [\vec{OᵢG}]ₓ is an anti-symmetric matrix generated by \vec{OᵢG}, Cₙⁱ is a direction cosine matrix from the navigation coordinate system to the incident light coordinate system, and Cₙⁱ may be represented by the heading angle φₑ;

$${C}_{n}^{i} = [ \begin{matrix}cos {φ}_{e} & sin {φ}_{e} & 0 \\ - s in {φ}_{e} & cos {φ}_{e} & 0 \\ 0 & 0 & 1\end{matrix} ] \qquad ( 5 )$$

finally, the heading angle φₑ of the E vector polarization orientation method is obtained by the following formula:

φₑ=90°−ϕ+φ_{S} (6)
wherein, ϕ is the polarization angle, and φ_{S} is the solar azimuth in the navigation coordinate system.

In the fitting symmetry axis polarization orientation method, polarization information of all regions is calculated, and polarization information of points around a solar meridian is extracted according to a remarkable characteristic that AOP distribution takes the solar meridian as a symmetry axis and presents anti-symmetric distribution. Subsequently, an AOP image is redrawn, and a point with an AOP value close to 90° is selected. Finally, these points are projected on a two-dimensional plane, the solar meridian is fitted by a least square method, an included angle α_{S} between the solar meridian and a carrier axis in a camera coordinate system is determined finally, and the heading angle φ_{b} of the fitting symmetry axis polarization orientation method may be expressed as:

φ_{b}=αₛ−φ_{S} (7)
wherein, φₑ is the heading angle obtained by the E vector polarization orientation method, ϕ is the polarization angle, φ_{S} is the solar azimuth in the navigation coordinate system, and φ_{b} is the heading angle obtained by the fitting symmetry axis polarization orientation method.

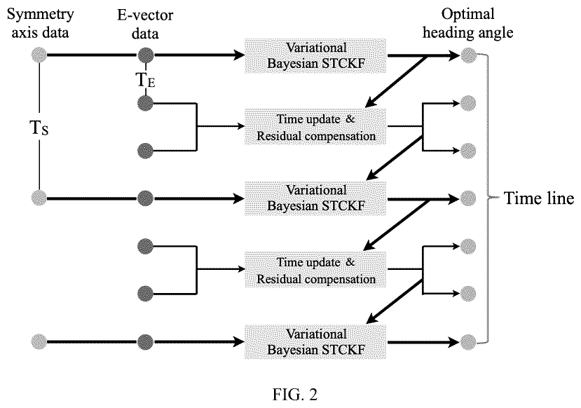

In step 2, the heading angle output by the E vector polarization orientation method is taken as a state quantity, the heading angle output by the fitting symmetry axis polarization orientation method is taken as an observed quantity, and the state quantity and the observed quantity are input into a multi-frequency variational Bayesian strong tracking cubature Kalman filter (MF-VBSTCKF) as shown in FIG. 2 to perform heading angle fusion.

A specific method of the heading angle fusion comprises:
assuming that the high-frequency state quantity and the low-frequency observed quantity both exist, approximating a joint posterior distribution of the state quantity and an observation noise variance by a variational Bayesian method based on the multi-frequency variational Bayesian strong tracking cubature Kalman filter, wherein the joint posterior distribution is expressed as a product of a Gaussian distribution and an inverse gamma distribution:

p(xₖ,Rₖ|z_{1:k})≈N(xₖ|\hat{x}ₖ,Pₖ)IG(Rₖ|λₖ,μₖ) (8)
wherein, p(xₖ, Rₖ|z_{1:k}) is a joint posterior distribution at a k moment, Pₖ is a covariance of filtering estimation at the k moment, xₖ, zₖ respectively represent a state quantity and an observed quantity at the k moment, \hat{x}ₖ represents an estimated value of the state quantity at the k moment, λₖ, μₖ are parameters of the inverse gamma distribution, N(·) represents the Gaussian distribution, IG(·) represents the inverse gamma distribution, and the observation noise variance Rₖ is calculated by the following formula:

Rₖ=(λₖ−n−1)⁻¹μₖ (9)
wherein, n is a number of dimensions of the observed quantity, and λₖ and μₖ are updated by the following formulas:

$${λ}_{k} = 1 + {λ}_{k / k - 1} \qquad ( 10 )$$

$${μ}_{k} = {μ}_{k / k - 1} + \frac{1}{m} {\sum }_{j = 1}^{m} ( {z}_{k} - {z}_{k , j} ) {( {z}_{k} - {z}_{k , j} )}^{T} \qquad ( 11 )$$

wherein, λ_{k/k-1} and μ_{k/k-1} are parameters of an inverse gamma distribution from a k−1 moment to the k moment, m=2n is a number of cubature points, j=1, 2, . . . , m, and z_{k,j} is an observed quantity of a j^{th} cubature point; and
meanwhile, adjusting P_{k/k-1} in real time by introducing a fading factor τₖ based on the multi-frequency variational Bayesian strong tracking cubature Kalman filter, thus tracking the state quantity quickly,

$${P}_{k / k - 1} = \frac{{τ}_{k}}{m} {\sum }_{j = 1}^{m} [ {{x}_{k / k - 1 , j} ( {x}_{k / k - 1 , j} )}^{T} - {{\hat{x}}_{k / k - 1} ( {\hat{x}}_{k / k - 1} )}^{T} ] + {Q}_{k} \qquad ( 12 )$$

wherein, p_{k|k-1} represents a covariance of filtering estimation from the k−1 moment to the k moment, x_{k/k-1,j} represents a predicted value of a state quantity of the j^{th} cubature point from the k−1 moment to the k moment, \hat{x}_{k/k-1} represents a predicted value of a state quantity from the k−1 moment to the k moment, Qₖ is a state noise variance, and τₖ is expressed as:

$${τ}_{k} = \frac{tr ( {V}_{k} - {R}_{k} )}{t r ( \frac{1}{m} {\sum }_{j = 1}^{m} {{z}_{k / k - 1 , j} ( {z}_{k / k - 1 , j} )}^{T} - {{\hat{z}}_{k / k - 1} ( {\hat{z}}_{k / k - 1} )}^{T} )} \qquad ( 13 )$$

$${V}_{k} = \{ \begin{matrix}{γ}_{k} {γ}_{k}^{T} , k = 1 \\ \frac{ρ {V}_{k - 1} + {γ}_{k} {γ}_{k}^{T}}{1 + ρ} , k > 1\end{matrix} \qquad ( 14 )$$

wherein, tr(·) represents a trace of a matrix, Vₖ is a covariance matrix of the residual error, z_{k/k-1,j} represents a predicted value of the observed quantity of the j^{th} cubature point from the k−1 moment to the k moment, \hat{z}_{k/k-1} represents a predicted value of the observed quantity from the k−1 moment to the k moment, ρ is a forgetting factor, and has a value of ρ=0.95, and γₖ is the residual error, and is expressed as:

γₖ=zₖ−Hₖ\hat{x}_{k/k-1} (15)
wherein, Hₖ represents the observation matrix.

In step 3, different methods are selected to update an optimal heading angle in low-frequency observed quantity sampling position and interval position. Since there is no low-frequency observed quantity in a sampling interval position, an observation noise variance cannot be updated by formulas (9) and (11), so that different updating methods need to be selected according to different situations.
(a) A high-frequency state quantity and a low-frequency observed quantity both exist in a low-frequency observed quantity sampling position, the observation matrix may be obtained according to an observation function, a residual error and an estimation error are calculated by using the observation matrix, and then an optimal heading angle at the moment is updated through the multi-frequency variational Bayesian strong tracking cubature Kalman filter.

Since the high-frequency state quantity and the low-frequency observed quantity both exist, the residual error may be expressed by formula (15), and the estimation error βₖ may be expressed as:

βₖ=xₖ−\hat{x}ₖ=((Hₖ^{T}−Hₖ)⁻¹Hₖ^{T}−Kₖ)γₖ (16)
when the low-frequency observed quantity exists, the update formula of the optimal heading angle is:

\hat{x}ₖ=\hat{x}_{k/k-1}+Kₖ(zₖ−\hat{z}_{k/k-1}) (17)
wherein, γₖ, βₖ are respectively a residual error and an estimation error at the k moment, xₖ, zₖ respectively represent a state quantity and an observed quantity at the k moment, \hat{x}ₖ represents an estimated value of the state quantity at the k moment, \hat{x}_{k/k-1} represents a predicted value of a state quantity from the k−1 moment to the k moment, Hₖ represents the observation matrix, Kₖ is a Kalman filtering gain, and \hat{z}_{k/k-1} represents a predicted value of an observed quantity from the k−1 moment to the k moment.
(b) In the low-frequency observed quantity sampling interval period, the low-frequency observed quantity does not exist, the observation noise variance cannot be updated by formulas (9) and (11), Rₖ₊₁ may tend to be infinitely great, and a Kalman gain Kₖ₊₁ at a k+1 moment may tend to be zero, so that the estimation error at the k+1 moment may be expressed as:

$${β}_{k + 1} = {x}_{k + 1} - {\hat{x}}_{k + 1} = {x}_{k + 1} - {\hat{x}}_{k + 1 / k} - {K}_{k + 1} ( {z}_{k + 1} - {H}_{k} {\hat{x}}_{k + 1 / k} ) = ( {x}_{k + 1} - {\hat{x}}_{k + \frac{1}{k}} ) - {K}_{k + 1} ( {H}_{k} {x}_{k + 1} - {H}_{k} {\hat{x}}_{k + 1 / k} ) = ( I - {K}_{k + 1} {H}_{k} ) {F}_{k} {β}_{k} \approx {F}_{k} {β}_{k} \qquad ( 18 )$$

wherein, Fₖ is a state transition matrix of system, and \hat{x}_{k+1/k} is a predicted value of the state quantity from a k moment to the k+1 moment.

Since the observed quantity zₖ₊₁ does not exist, it is impossible to update the residual error by formula (15), and at the moment, the residual error is updated by using the estimation error:

γₖ₊₁=zₖ₊₁−Hₖ\hat{x}_{k+1/k}=Hₖxₖ₊₁−Hₖ\hat{x}_{k+1/k}≈HₖFₖ·βₖ (19)

On the basis above, when the low-frequency observed quantity does not exist, it can be known from formula (18) that the estimation error may be continuously self-updated, and it can be known from formula (19) that the residual error may be expressed by the estimation error. In conventional filtering, the optimal heading angle may be expressed by formula (17), and in the low-frequency observed quantity sampling interval, a magnitude of the Kalman gain is unknown and a value of the Kalman gain is very small theoretically, so that an estimation formula of the optimal heading angle may be adjusted into:

\hat{x}ₖ₊₁=\hat{x}_{k+1/k}+∈ₖ₊₁γₖ₊₁ (20)
wherein, βₖ₊₁, γₖ₊₁ are respectively the estimation error and the residual error at the k+1 moment, \hat{x}ₖ₊₁ represents an estimated value of the state quantity at the k+1 moment, and ∈ₖ₊₁=diag([∈_{1,k}, ∈_{2,k}, . . . ∈_{n,k+1}]) is an adjustment factor, which is equivalent to the Kalman gain.

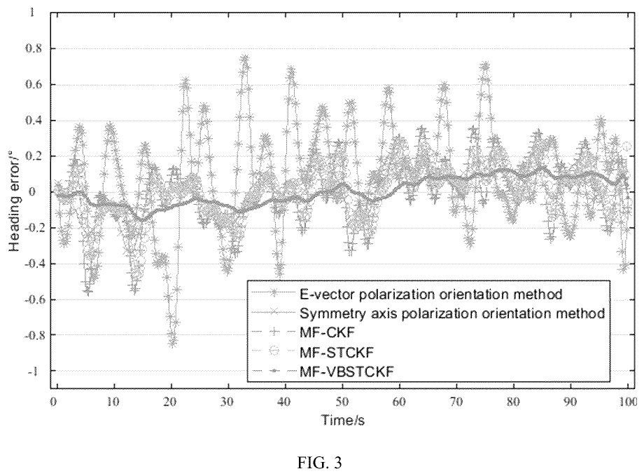

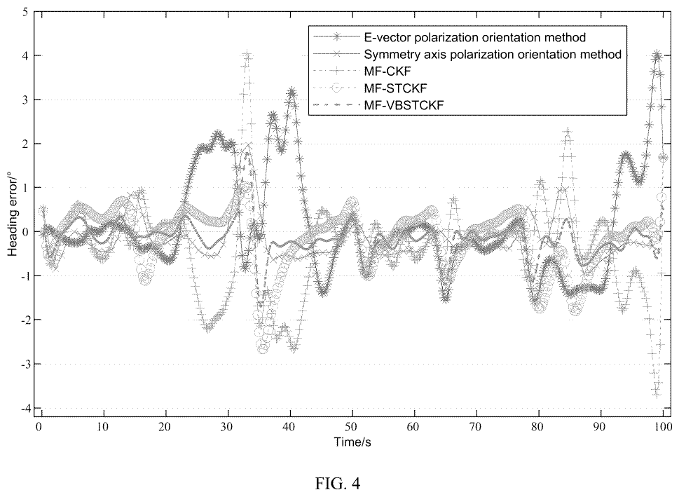

In order to verify an effect of the method, the explanation is made by the following comparative experiment. The polarization compass used in the experiment is composed of a polarization camera and a NVIDIA Jetson TX2 development board. A heading angle of a reference system comes from a high-precision compact optical fiber integrated navigation system SPAN-KVH1750, a course precision may reach 0.035°, and a sampling frequency is set to be 4 HZ. FIG. 1 is a flow chart of the polarization fusion orientation method for the occluded environment, wherein a sampling frequency of the E vector polarization orientation method is 4 HZ, and a sampling frequency of the fitting symmetry axis polarization orientation method is 1 HZ. FIG. 2 is a schematic diagram of the multi-frequency variational Bayesian strong tracking cubature Kalman filter, and T_{E} and T_{S} are respectively sampling periods of the E vector polarization orientation method and the fitting symmetry axis polarization orientation method. In order to prove the effectiveness of the present invention, results of comparative experiments of different fusion algorithms by a single polarization orientation method and two polarization orientation methods in different occluded environment are given. The fusion algorithms used in comparison comprise: a multi-frequency cubature Kalman filtering algorithm (MF-CKF), a multi-frequency strong tracking cubature Kalman filtering algorithm (MF-STCKF) and a multi-frequency variational Bayesian strong tracking cubature Kalman filtering algorithm (MF-VBSTCKF). FIG. 3 is an error graph of a heading angle of each method in a static occluded environment; and FIG. 4 is an error graph of a heading angle of each method in a dynamic occluded environment. It can be seen from FIG. 3 and FIG. 4 that, due to the influence of shielding, the heading angle obtained by the E vector polarization orientation method is changed greatly, which reduces the course precision. The heading angle obtained by the fitting symmetry axis polarization orientation method can also maintain a high precision even in the case of shielding, but an output frequency is low. Output frequencies of all fusion algorithms are consistent with the E vector polarization orientation method by performing residual error compensation on the state quantity in a low-frequency data interval. In the three fusion methods, the estimation precision of the optimal heading angle of the MF-CKF is the worst, and a target state may be better tracked by introducing a strong tracking fading factor by the MF-STCKF. However, due to the lack of real-time estimation and update of the observation noise, there are still errors. The MF-VBSTCKF can significantly improve an estimation performance of the heading angle and reduce a course error while maintaining a high tracking precision by utilizing the advantages of the variational Bayesian method in adaptive estimation of time-varying noise. The above may show that the proposed polarization fusion orientation method for the occluded environment can realize high-precision and high-robustness heading angle measurement.

Those described above are only preferred embodiments of the present invention, and are not intended to limit the present invention. Any modifications, equivalent substitutions and improvements made without departing from the spirit and principle of the present invention shall fall within the scope of protection of the present invention.

What is claimed is:

1. A polarization fusion orientation method for an occluded environment, comprising the following steps of:
step 1: acquiring a sky polarization image through a polarization camera, and calculating a heading angle by an E-vector polarization orientation method and a symmetry axis polarization orientation method respectively according to the sky polarization image, wherein when the fitting symmetry axis polarization orientation method is used, a sampling frequency is relatively low as the image needs to be redrawn;
step 2: taking the heading angle output by the E vector polarization orientation method as a state quantity, taking the heading angle output by the fitting symmetry axis polarization orientation method as an observed quantity, and inputting the state quantity and the observed quantity into a multi-frequency variational Bayesian strong tracking cubature Kalman filter to perform heading angle fusion; and
step 3: making a high-frequency state quantity and a low-frequency observed quantity exist in a low-frequency observed quantity sampling position when an observation matrix is given, calculating a residual error and an estimation error by using the observation matrix, and then updating an optimal heading angle at the moment through the multi-frequency variational Bayesian strong tracking cubature Kalman filter; and
making the low-frequency observed quantity non-exist during a low-frequency observed quantity sampling interval period when a state transition matrix is given, updating the estimation error by using the state transition matrix, updating the residual error by using the estimation error updated, and updating the optimal heading angle by using the residual error updated.

2. The polarization fusion orientation method for the occluded environment according to claim 1, wherein in the step 1, in the E vector polarization orientation method, polarization information of a zenith region is calculated first, a solar azimuth φ_{S} in a navigation coordinate system is acquired by consulting a solar ephemeris, and then the heading angle is acquired according to an E vector of incident light perpendicular to a plane composed of an observation direction and a solar vector in a Rayleigh scattering theory; and
in the fitting symmetry axis polarization orientation method, a polarization angle image is redrawn and a point with an AOP value close to 90° is selected to fit a solar meridian by calculating polarization information of all regions, an included angle αₛ between the solar meridian and a carrier axis in a camera coordinate system is determined finally, and the heading angle is calculated by φ_{S}, αₛ;
the heading angles of the two methods are respectively calculated according to ϕ, φ_{S}, αₛ:
φₑ=90°−ϕ+φ_{S} (6)
φ_{b}=αₛ−φ_{S} (7)
wherein, φₑ is the heading angle obtained by the E vector polarization orientation method, ϕ is the polarization angle, φ_{S} is the solar azimuth in the navigation coordinate system, and φ_{b} is the heading angle obtained by the fitting symmetry axis polarization orientation method.

3. The polarization fusion orientation method for the occluded environment according to claim 1, wherein in the step 2, a specific method of the heading angle fusion comprises:
assuming that the high-frequency state quantity and the low-frequency observed quantity both exist, approximating a joint posterior distribution of the state quantity and an observation noise variance by a variational Bayesian method based on the multi-frequency variational Bayesian strong tracking cubature Kalman filter, wherein the joint posterior distribution is expressed as a product of a Gaussian distribution and an inverse gamma distribution:
p(xₖ,Rₖ|z_{1:k})≈N(xₖ|\hat{x}ₖ,Pₖ)IG(Rₖ|λₖ,μₖ) (8)
wherein, p(xₖ, Rₖ|z_{1:k}) is a joint posterior distribution at a k moment, Pₖ is a covariance of filtering estimation at the k moment, xₖ, zₖ respectively represent a state quantity and an observed quantity at the k moment, \hat{x}ₖ represents an estimated value of the state quantity at the k moment, λₖ, μₖ are parameters of the inverse gamma distribution, N(·) represents the Gaussian distribution, IG(·) represents the inverse gamma distribution, and the observation noise variance Rₖ is calculated by the following formula:
Rₖ=(λₖ−n−1)⁻¹μₖ (9)
wherein, n is a number of dimensions of the observed quantity, and λₖ and μₖ are updated by the following formulas:
$${λ}_{k} = 1 + {λ}_{k / k - 1} \qquad ( 10 )$$
$${μ}_{k} = {μ}_{k / k - 1} + \frac{1}{m} {\sum }_{j = 1}^{m} ( {z}_{k} - {z}_{k , j} ) {( {z}_{k} - {z}_{k , j} )}^{T} \qquad ( 11 )$$
wherein, λ_{k/k-1} and μ_{k/k-1} are parameters of an inverse gamma distribution from a k−1 moment to the k moment, m=2n is a number of cubature points, j=1, 2, . . . , m, and z_{k,j} is an observed quantity of a j^{th} cubature point; and
meanwhile, adjusting P_{k/k-1} in real time by introducing a fading factor τₖ based on the multi-frequency variational Bayesian strong tracking cubature Kalman filter,
$${P}_{k / k - 1} = \frac{{τ}_{k}}{m} {\sum }_{j = 1}^{m} [ {{x}_{k / k - 1 , j} ( {x}_{k / k - 1 , j} )}^{T} - {{\hat{x}}_{k / k - 1} ( {\hat{x}}_{k / k - 1} )}^{T} ] + {Q}_{k} \qquad ( 12 )$$
wherein, P_{k/k-1} represents a covariance of filtering estimation from the k−1 moment to the k moment, x_{k/k-1,j} represents a predicted value of a state quantity of the j^{th} cubature point from the k−1 moment to the k moment, \hat{x}_{k/k-1} represents a predicted value of a state quantity from the k−1 moment to the k moment, Qₖ is a state noise variance, and τₖ is expressed as:
$${τ}_{k} = \frac{tr ( {V}_{k} - {R}_{k} )}{t r ( \frac{1}{m} {\sum }_{j = 1}^{m} {{z}_{k / k - 1 , j} ( {z}_{k / k - 1 , j} )}^{T} - {{\hat{z}}_{k / k - 1} ( {\hat{z}}_{k / k - 1} )}^{T} )} \qquad ( 13 )$$
$${V}_{k} = \{ \begin{matrix}{γ}_{k} {γ}_{k}^{T} , k = 1 \\ \frac{ρ {V}_{k - 1} + {γ}_{k} {γ}_{k}^{T}}{1 + ρ} , k > 1\end{matrix} \qquad ( 14 )$$
wherein, tr(·) represents a trace of a matrix, Vₖ is a covariance matrix of the residual error, z_{k/k-1,j} represents a predicted value of the observed quantity of the j^{th} cubature point from the k−1 moment to the k moment, \hat{z}_{k/k-1} represents a predicted value of the observed quantity from the k−1 moment to the k moment, ρ is a forgetting factor, and has a value of ρ=0.95, and γₖ is the residual error, and is expressed as:
γₖ=zₖ−Hₖ\hat{x}_{k/k-1} (15)
wherein, Hₖ represents the observation matrix.

4. The polarization fusion orientation method for the occluded environment according to claim 1, wherein in the step 3, the high-frequency state quantity and the low-frequency observed quantity both exist in the low-frequency observed quantity sampling position, and calculation formulas of the residual error, the estimation error and the optimal heading angle are as follows:
γₖ=zₖ−Hₖ\hat{x}_{k/k-1} (15)
βₖ=xₖ−\hat{x}ₖ=((Hₖ^{T}−Hₖ)⁻¹Hₖ^{T}−Kₖ)γₖ (16)
\hat{x}ₖ=\hat{x}_{k/k-1}+Kₖ(zₖ−\hat{z}_{k/k-1}) (17)
wherein, γₖ, βₖ are respectively a residual error and an estimation error at the k moment, xₖ, zₖ respectively represent a state quantity and an observed quantity at the k moment, \hat{x}ₖ represents an estimated value of the state quantity at the k moment, \hat{x}_{k/k-1} represents a predicted value of a state quantity from the k−1 moment to the k moment, Hₖ represents the observation matrix, Kₖ is a Kalman filtering gain, and \hat{z}_{k/k-1} represents a predicted value of an observed quantity from the k−1 moment to the k moment.

5. The polarization fusion orientation method for the occluded environment according to claim 1, wherein in the step 3, the low-frequency observed quantity does not exist during the low-frequency observed quantity sampling interval period, and calculation formulas of the estimation error, the residual error and the optimal heading angle are as follows:
βₖ₊₁≈Fₖβₖ (21)
γₖ₊₁≈HₖFₖ·βₖ (22)
\hat{x}ₖ₊₁=\hat{x}_{k+1/k}+∈ₖ₊₁γₖ₊₁ (23)
wherein, βₖ₊₁, γₖ₊₁ respectively represent an estimation error and a residual error at the k+1 moment, Fₖ is the state transition matrix of the system, \hat{x}ₖ₊₁ represents an estimated value of a state quantity at the k+1 moment, \hat{x}_{k+1/k} represents a predicted value of a state quantity from the k moment to the k+1 moment, and ∈ₖ₊₁=diag([∈_{1,k}, ∈_{2,k}, . . . ∈_{n,k+1}]) is an adjusting factor.

6. The polarization fusion orientation method for the occluded environment according to claim 2, wherein in the step 2, a specific method of the heading angle fusion comprises:
assuming that the high-frequency state quantity and the low-frequency observed quantity both exist, approximating a joint posterior distribution of the state quantity and an observation noise variance by a variational Bayesian method based on the multi-frequency variational Bayesian strong tracking cubature Kalman filter, wherein the joint posterior distribution is expressed as a product of a Gaussian distribution and an inverse gamma distribution:
p(xₖ,Rₖ|z_{1:k})≈N(xₖ|\hat{x}ₖ,Pₖ)IG(Rₖ|λₖ,μₖ) (8)
wherein, p(xₖ, Rₖ|z_{1:k}) is a joint posterior distribution at a k moment, Pₖ is a covariance of filtering estimation at the k moment, xₖ, zₖ respectively represent a state quantity and an observed quantity at the k moment, \hat{x}ₖ represents an estimated value of the state quantity at the k moment, λₖ,μₖ are parameters of the inverse gamma distribution, N(·) represents the Gaussian distribution, IG(·) represents the inverse gamma distribution, and the observation noise variance Rₖ is calculated by the following formula:
Rₖ=(λₖ−n−1)⁻¹μₖ (9)
wherein, n is a number of dimensions of the observed quantity, and λₖ and μₖ are updated by the following formulas:
$${λ}_{k} = 1 + {λ}_{k / k - 1} \qquad ( 10 )$$
$${μ}_{k} = {μ}_{k / k - 1} + \frac{1}{m} {\sum }_{j = 1}^{m} ( {z}_{k} - {z}_{k , j} ) {( {z}_{k} - {z}_{k , j} )}^{T} \qquad ( 11 )$$
wherein, λ_{k/k-1} and μ_{k/k-1} are parameters of an inverse gamma distribution from a k−1 moment to the k moment, m=2n is a number of cubature points, j=1, 2, . . . , m, and z_{k,j} is an observed quantity of a j^{th} cubature point; and
meanwhile, adjusting P_{k/k-1} in real time by introducing a fading factor τₖ based on the multi-frequency variational Bayesian strong tracking cubature Kalman filter,
$${P}_{k / k - 1} = \frac{{τ}_{k}}{m} {\sum }_{j = 1}^{m} [ {{x}_{k / k - 1 , j} ( {x}_{k / k - 1 , j} )}^{T} - {{\hat{x}}_{k / k - 1} ( {\hat{x}}_{k / k - 1} )}^{T} ] + {Q}_{k} \qquad ( 12 )$$
wherein, P_{k/k-1} represents a covariance of filtering estimation from the k−1 moment to the k moment, x_{k/k-1,j} represents a predicted value of a state quantity of the j^{th} cubature point from the k−1 moment to the k moment, \hat{x}_{k/k-1} represents a predicted value of a state quantity from the k−1 moment to the k moment, Qₖ is a state noise variance, and τₖ is expressed as:
$${τ}_{k} = \frac{tr ( {V}_{k} - {R}_{k} )}{t r ( \frac{1}{m} {\sum }_{j = 1}^{m} {{z}_{k / k - 1 , j} ( {z}_{k / k - 1 , j} )}^{T} - {{\hat{z}}_{k / k - 1} ( {\hat{z}}_{k / k - 1} )}^{T} )} \qquad ( 13 )$$
$${V}_{k} = \{ \begin{matrix}{γ}_{k} {γ}_{k}^{T} , k = 1 \\ \frac{ρ {V}_{k - 1} + {γ}_{k} {γ}_{k}^{T}}{1 + ρ} , k > 1\end{matrix} \qquad ( 14 )$$
wherein, tr(·) represents a trace of a matrix, Vₖ is a covariance matrix of the residual error, z_{k/k-1,j} represents a predicted value of the observed quantity of the j^{th} cubature point from the k−1 moment to the k moment, \hat{z}_{k/k-1} represents a predicted value of the observed quantity from the k−1 moment to the k moment, ρ is a forgetting factor, and has a value of ρ=0.95, and γₖ is the residual error, and is expressed as:
γₖ=zₖ−Hₖ\hat{x}_{k/k-1} (15)
wherein, Hₖ represents the observation matrix.

7. The polarization fusion orientation method for the occluded environment according to claim 2, wherein in the step 3, the high-frequency state quantity and the low-frequency observed quantity both exist in the low-frequency observed quantity sampling position, and calculation formulas of the residual error, the estimation error and the optimal heading angle are as follows:
γₖ=zₖ−Hₖ\hat{x}_{k/k-1} (15)
βₖ=xₖ−\hat{x}ₖ=((Hₖ^{T}−Hₖ)⁻¹Hₖ^{T}−Kₖ)γₖ (16)
\hat{x}ₖ=\hat{x}_{k/k-1}+Kₖ(zₖ−\hat{z}_{k/k-1}) (17)
wherein, γₖ, βₖ are respectively a residual error and an estimation error at the k moment, xₖ, zₖ respectively represent a state quantity and an observed quantity at the k moment, \hat{x}ₖ represents an estimated value of the state quantity at the k moment, \hat{x}_{k/k-1} represents a predicted value of a state quantity from the k−1 moment to the k moment, Hₖ represents the observation matrix, Kₖ is a Kalman filtering gain, and \hat{z}_{k/k-1} represents a predicted value of an observed quantity from the k−1 moment to the k moment.

8. The polarization fusion orientation method for the occluded environment according to claim 2, wherein in the step 3, the low-frequency observed quantity does not exist during the low-frequency observed quantity sampling interval period, and calculation formulas of the estimation error, the residual error and the optimal heading angle are as follows:
βₖ₊₁≈Fₖβₖ (21)
γₖ₊₁≈HₖFₖ·βₖ (22)
\hat{x}ₖ₊₁=\hat{x}_{k+1/k}+∈ₖ₊₁γₖ₊₁ (23)
wherein, βₖ₊₁, γₖ₊₁ respectively represent an estimation error and a residual error at the k+1 moment, Fₖ is the state transition matrix of the system, \hat{x}ₖ₊₁ represents an estimated value of a state quantity at the k+1 moment, \hat{x}_{k+1/k} represents a predicted value of a state quantity from the k moment to the k+1 moment, and ∈ₖ₊₁=diag([∈_{1,k}, ∈_{2,k}, . . . ∈_{n,k+1}]) is an adjusting factor.
